(19) United States
(12) Patent Application Publication
(10) Pub. No.: US 2026/0175130 A1
(43) Pub. Date: Jun. 25, 2026

(54) INTERACTION CONTROL METHOD AND APPARATUS IN GAME, AND ELECTRONIC DEVICE

(71) Applicant: NETEASE (HANGZHOU) NETWORK CO., LTD., Hangzhou, Zhejiang (CN)

(72) Inventor: Mingxin WU, Hangzhou, Zhejiang (CN)

(73) Assignee: NETEASE (HANGZHOU) NETWORK CO., LTD., Hangzhou, Zhejiang (CN)

(21) Appl. No.: 19/126,045

(22) PCT Filed: Apr. 6, 2023
(86) PCT No.: PCT/CN2023/086596

§ 371 Date: Apr. 30, 2025

(30) Foreign Application Priority Data
Nov. 4, 2022 (CN) 202211374646.7

(51) Int. Cl. A63F 13/573; A63F 13/533; A63F 13/537; A63F 13/58

(52) U.S. Cl. CPC A63F 13/573; A63F 13/533; A63F 13/537; A63F 13/58

(57) ABSTRACT

An interaction control method in a game, comprising: controlling a controlled virtual object to move in a game scene, wherein the game scene comprises a plurality of virtual objects, and the controlled virtual object is one of the plurality of virtual objects; in response to a specified trigger event, determining at least some of alternative props from a specified prop set, and displaying the alternative props; in response to a selection operation for a first prop in the alternative props, controlling the controlled virtual object to obtain the first prop; and in response to a trigger operation for the first prop, controlling to perform a game behavior corresponding to the first prop in the game scene. In the mode, a player can select a prop from alternative props determined in the prop set, acquisition channels of game props are enriched, and different props can be obtained according to the change of a game process, so that functions and types of game props are enriched, competitive experience of players participating in games is improved, and the utilization rate of service resources is improved.

### CROSS-REFERENCE TO RELATED APPLICATIONS

The present application is a U.S. National Stage of International Application No. PCT/CN2023/086596, filed on Apr. 6, 2023, which claims priority to Chinese patent application No. 202211374646.7, filed on Nov. 4, 2022, both of which are incorporated herein by reference in their entireties for all purpose.

### TECHNICAL FIELD

The present disclosure relates to the field of game technology, and in particular to interactive control method and device and an electronic device in a game.

### BACKGROUND

For multiplayer online tactical competitive games, players can select game props from the warehouse, put the selected game props into the backpack, and then control the virtual character to carry the backpack into the game session. The virtual character can also pick up game props in the game scene of the game session. Game props can be used to attack enemy characters, heal the controlled character itself or friend characters, etc. In this way, the way to obtain game props is relatively simple, resulting in limited functions and types of game props available to players in the game session, affecting the player's game competitive experience, leading to player loss, and causing idling and waste of game service resources and server equipment resources.

### SUMMARY

According to an aspect of the present disclosure, there is provided an interactive control method in a game, including: providing a graphical user interface through a terminal device, wherein the graphical user interface includes an interface of a current game session; the interface of the current game session includes a game scene and a controlled virtual object located in the game scene; the controlled virtual object is controlled by the terminal device; controlling the controlled virtual object to move in the game scene, wherein the game scene includes multiple virtual objects, and the controlled virtual object belongs to one of the multiple virtual objects; in response to a specified trigger event, determining at least some alternative props from a specified prop set, and displaying the alternative props; in response to a selection operation for the first prop in the alternative props, controlling the controlled virtual object to acquire a first prop; and in response to a trigger operation for the first prop, controlling to perform a game behavior corresponding to the first prop in the game scene.

According to an aspect of the present disclosure, there is provided an electronic device, including a processor and a memory. The memory stores machine executable instructions that can be executed by the processor, and the processor executes the machine executable instructions to implement the above interactive control method in the game.

According to an aspect of the present disclosure, there is provided a non-transitory machine-readable storage medium. The non-transitory machine-readable storage medium stores machine executable instructions, and when the machine executable instructions are called and executed by a processor, the machine executable instructions cause the processor to implement the above interactive control method in the game.

### BRIEF DESCRIPTION OF THE DRAWINGS

FIG. 1 is a flow chart of an interactive control method in a game provided by one of the embodiments of the present disclosure;

FIG. 2 is a display schematic diagram of an interactive prompt control provided by one of the embodiments of the present disclosure;

FIG. 3 is a display schematic diagram of a prop acquisition control provided by one of the embodiments of the present disclosure;

FIG. 4 is a schematic diagram of an interactive control device in a game provided by one of the embodiments of the present disclosure;

FIG. 5 is a structural schematic diagram of an electronic device provided by one of the embodiments of the present disclosure.

### DETAILED DESCRIPTION

In order to make the purpose, technical solution and advantages of the embodiments of the present disclosure clearer, the technical solution of the present disclosure will be described clearly and completely in conjunction with the accompanying drawings. Obviously, the described embodiments are part of the embodiments of the present disclosure, not all of the embodiments. Based on the embodiments in the present disclosure, all other embodiments obtained by those skilled in the art without creative work are within the scope of protection of the present disclosure.

At present, the way to obtain game props is relatively single, resulting in limited functions and types of game props available to players in the game session, affecting the game competition experience of players. Based on this, the embodiments of the present disclosure provide interactive control method and device and an electronic device in a game, and the technology can be applied to various games, for example, games related to tactical competition through props.

The interactive control method in the game in one embodiment of the present disclosure can be run on a local terminal device or a server. When the interactive control method in the game is run on a server, the method can be implemented and executed based on a cloud interactive system, where the cloud interactive system includes a server and a client device.

In an optional embodiment, various cloud applications can be run under the cloud interactive system, such as a cloud game. Taking the cloud game as an example, the cloud game refers to a game mode based on cloud computing. In the operation mode of the cloud game, the operating entity of the game program and the presentation entity of the game screen are separated. The storage and operation of the interactive control method in the game are completed on the cloud game server. The role of the client device is to receive and send data and present the game screen. For example, the client device can be a display device with data transmission function close to the user side, such as a mobile terminal, a TV, a computer, a handheld computer, etc.; but the cloud game server in the cloud is responsible for information processing. When playing the game, the player operates the client device to send an operation instruction to the cloud game server. The cloud game server runs the game according to the operation instruction, encodes and compresses the game screen and other data, and returns it to the client device through the network. Finally, the client device decodes and outputs the game screen.

In an embodiment, taking the game as an example, the local terminal device stores the game program and is configured to present the game screen. The local terminal device is configured to interact with the player through a graphical user interface. That is, the game program is downloaded and installed and run conventionally by the electronic device. The local terminal device can provide the graphical user interface to the player in a variety of ways. For example, it can be rendered and displayed on the display screen of the terminal, or provided to the player through holographic projection. For example, the local terminal device may include a display screen and a processor. The display screen is configured to present a graphical user interface, and the graphical user interface includes a game screen. The processor is configured to run the game, generate the graphical user interface, and control the display of the graphical user interface on the display screen.

In a possible implementation, the embodiment of the present disclosure provides an interactive control method in a game. A graphical user interface is provided through a terminal device. The terminal device may be the local terminal device mentioned above, or may be a client device in the cloud interactive system mentioned above.

Taking the TPS (Third-Personal Shooting) tactical competitive game as an example, at the beginning of the game session, a game scene is preset, and the game scene may be an island terrain, a mountain terrain, an urban terrain, etc. The flying vehicle flies over the game scene along a preset path, and multiple virtual objects are in the virtual vehicle. During the flight of the flying vehicle, the player can control the controlled virtual object to jump out of the flying vehicle at any time and land in the game scene by parachuting.

A game session is usually played by multiple players, so there are multiple virtual objects in the game scene corresponding to the game session. Each player controls a virtual object to participate in the game session. Virtual objects can participate in the game session alone or in a team, which can be determined according to the session requirement for the game session. Virtual objects usually carry weapons and props, such as guns, bullets, grenades, etc., and can also carry medical props, such as blood packs, etc. Props may be scattered in the game scene, and virtual objects can pick up and use them. When there is a virtual object in a defeated state in the game scene, the props carried by the virtual object can also be picked up and used by other virtual objects.

As the progress of the game session changes, there will be safe areas and unsafe areas in the game scene. The health points or other skill abilities of virtual objects in unsafe areas will continue to decrease; during the change of the session progress, the area range of the safe area will become smaller and smaller, thereby guiding the surviving virtual objects to concentrate in the safe area.

For a controlled virtual object controlled by a terminal device, the controlled virtual object can attack other virtual object through weapons and props, resulting in a decrease in the health points, skill points or other object attributes of the attacked virtual object. When the attacked virtual object is defeated, the controlled virtual object can pick up some props of the defeated virtual object and use them. If the controlled virtual object is in an unsafe area, its health points will continue to decrease, and it needs to go to a safe area as soon as possible. For example, it can quickly reach the safe area through a virtual vehicle.

When the controlled virtual object is in an unsafe area for a long time, or is attacked by other virtual object, its health points will decrease. When the health points are reduced to zero, the controlled virtual object is defeated. If all other virtual objects in the game scene are defeated, and the controlled virtual object survives, then at this time, the controlled virtual object or the team to which the controlled virtual object belongs wins the game session. If the controlled virtual object is defeated but the teammates of the team to which the controlled virtual object belongs win the game session, the team to which the controlled virtual object belongs wins the game session. If the controlled virtual object has no teammates and the controlled virtual object is defeated, then the game session of the controlled virtual object fails. If the controlled virtual object has teammates, and both the controlled virtual object and the teammates are defeated, the game session of the controlled virtual object fails.

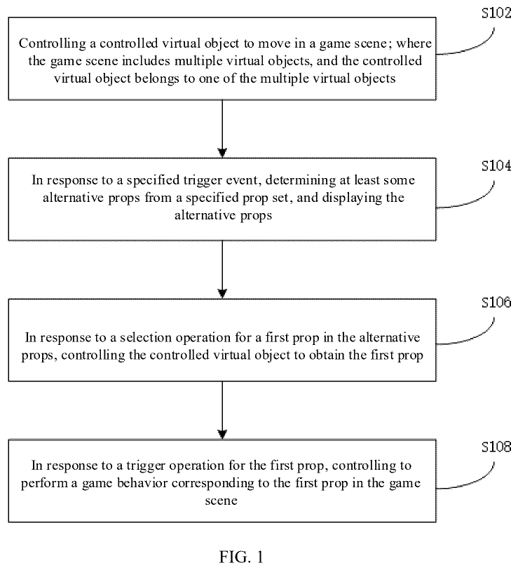

Based on the above game scene, firstly, an interactive control method in a game disclosed in an embodiment of the present disclosure is introduced in detail. As shown in FIG. 1, in the interactive control method in the game, a graphical user interface is provided through a terminal device, where the terminal device can be the local terminal device described above or the client device described above. The graphical user interface includes a current game session interface. The current game session interface includes a game scene and a controlled virtual object located in the game scene. The controlled virtual object is controlled by the terminal device. In an implementation, at the beginning of the game session, the controlled virtual object lands from the flying vehicle into the game scene, and moves, picks up props, performs shooting operations, etc. in the game scene. The virtual camera follows the movement of the controlled virtual object. In a third-person game, the virtual camera follows behind the controlled virtual object, and the scene picture obtained includes the controlled virtual object. In a first-person game, the virtual camera captures the scene picture under the field of view of the controlled virtual object, and the scene picture may include some body parts of the controlled virtual object.

The above-mentioned graphical user interface also displays interactive controls, such as move controls, various skill controls, etc. The player triggers these interactive controls through the terminal device, thereby controlling the position, posture, action, etc. of the controlled virtual object in the game scene through the terminal device.

The method includes the following steps:
Step S102, controlling a controlled virtual object to move in a game scene;
where the game scene includes multiple virtual objects, and the controlled virtual object belongs to one of the multiple virtual objects;
The graphical user interface displays a move control, such as move joysticks. The player controls the controlled virtual object to move in the game scene by triggering the move control. In a game session, multiple virtual objects participate together. If the controlled virtual object participates in the game session alone, then all virtual objects other than the controlled virtual object are enemy objects. If the controlled virtual object is teamed up with other virtual objects to participate in the game session together, virtual objects other than teammate objects are enemy objects.

The object state of the controlled virtual object may be affected by a specified action of a first virtual object among the multiple virtual objects, or by a scene state of a scene location where the controlled virtual object is located. The first virtual object is the controlled virtual object or a virtual object other than the controlled virtual object.

The object state of the controlled virtual object may include numerical states such as health points and magic points. The object state of the controlled virtual object may be affected by any virtual object in the game scene, and may also be affected by the scene state of the scene location in the game scene. For example, when the first virtual object is a virtual object other than the controlled virtual object, the first virtual object may perform an attack action on the controlled virtual object, such as shooting with a gun, releasing an attack prop, etc. If the controlled virtual object is hit, the health points of the controlled virtual object will decrease. When the first virtual object is a teammate object, the first virtual object may perform a rescue action on the controlled virtual object, such as using a blood supply prop on the controlled virtual object, etc. At this time, the health points of the controlled virtual object will increase. For another example, the first virtual object may also be the controlled virtual object itself. For example, the controlled virtual object uses a blood supply prop on itself, and at this time, the health points of the controlled virtual object will also increase.

In addition, the object state of the controlled virtual object will also be affected by the scene state of the scene location where the controlled virtual object is located. For example, the scene state can include a safe state and an unsafe state. Based on the scene state, the game scene is divided into a safe area and an unsafe area. If the controlled virtual object is located in an unsafe area, the health points of the controlled virtual object may be reduced, and the skills or prop effects of the controlled virtual object may also be affected, thereby affecting the object state of the controlled virtual object.

Step S104, in response to a specified trigger event, determining at least some alternative props from a specified prop set, and displaying the alternative props;

This embodiment aims to provide a variety of game props in the game session to meet the player's game combat needs and promote the progress of the game session. Based on this, one or more specified trigger events can be pre-set, and when the session state of the game session meets the specified trigger event, the prop acquisition control is displayed in the graphical user interface. The specified trigger event can be set according to the session time of the game session, situation changes, survival status of virtual objects in the scene, object level, etc.

For example, the game system may have multiple alternative prop sets preset, and the prop types, quantities, functions, etc. in different alternative prop sets may be different. According to the session progress of the game session, a specified prop set is determined from the alternative prop sets. The session progress can be the game session time or the session progress node, and the specified prop sets corresponding to different session progresses can be different or partially different, so that the controlled virtual object can obtain props of different types or attributes in different session progresses.

In actual implementation, one or more alternative props can be determined from the specified prop set according to preset rules, for example, randomly distributed, randomly drawn, or assigned to each virtual object in a certain order. After determining the alternative props, the alternative props are displayed in the graphical user interface, and information such as the prop usage of the alternative props can also be displayed.

After the specified trigger event occurs, at least some of the alternative props can be automatically determined from the specified prop set. A prop acquisition control can also be displayed in the graphical user interface first. The prop acquisition control can be displayed at a specified position in the graphical user interface, and at the same time, a prompt message can be displayed to prompt the player to obtain the prop by triggering the prop acquisition control.

After responding to the specified trigger event, the game system can display the aforementioned prop acquisition control on the terminal device corresponding to each virtual object in the survival state, and then the player corresponding to each virtual object in the survival state can determine the alternative props through the prop acquisition control. The alternative props corresponding to different virtual objects can be the same or different. For some special props, only one virtual object can obtain and use them in a game session.

Step S106, in response to a selection operation for a first prop in the alternative props, controlling the controlled virtual object to obtain the first prop.

There may be one or more alternative props. After the alternative props are displayed in the graphical user interface, the player can select one or more of them, and the selected prop is the above-mentioned first prop. After the first prop is selected, it can enter the backpack of the controlled virtual object, and the controlled virtual object can use the first prop.

Step S108, in response to a trigger operation for the first prop, controlling a game behavior corresponding to the first prop to be executed in the game scene.

The above-mentioned first prop can be configured to: update the object state of the prop affected object of the first prop, and/or update the specified scene state of the game scene. The prop affected object is the controlled virtual object or a virtual object other than the controlled virtual object. The above-mentioned game behavior is associated with the prop function of the first prop. In this embodiment, the first prop can have multiple prop functions. The controlled virtual object can use the first prop on other virtual objects or itself, or on the game scene. Therefore, the prop affected object of the first prop can be other virtual objects, the controlled virtual object itself, or the game scene. The prop affected object can be determined according to the function of the first prop and the virtual objects near the first prop when the first prop is used.

For example, when the first prop is an offensive prop, such as a firearm, a grenade, etc., virtual objects within the skill release range of the first prop is the prop affected objects, and the health points of the prop affected objects may be reduced. When the first prop is a prop that changes the scene state, the prop affected object is the game scene, or a local scene area in the game scene. After the first prop is released, the terrain, weather, etc. of the game scene or the target scene area change.

In the above interactive control method in the game, a graphical user interface is provided through a terminal device. The graphical user interface includes a current game session interface. The current game session interface includes a game scene and a controlled virtual object located in the game scene. The controlled virtual object is controlled by the terminal device. The controlled virtual object is controlled to move in the game scene, where the game scene includes multiple virtual objects. The controlled virtual object belongs to one of the multiple virtual objects. In response to a specified trigger event, at least some alternative props are determined from a specified prop set, and the alternative props are displayed. In response to a selection operation on a first prop among the alternative props, the controlled virtual object is controlled to obtain the first prop. In response to a trigger operation on the first prop, the game behavior corresponding to the first prop is controlled to be executed in the game scene. In the above method, in the game session, a prop set is determined based on the session progress, and alternative props are determined from the prop set. Players can select props from the alternative props. This method enriches the acquisition ways of game props, and different props can be obtained according to the changes in the session progress, so that the functions and types of game props are richer, which improves the competitive experience of players participating in the game, improves the utilization rate of service resources, makes full use of game service resources and server equipment resources, and avoids idling and waste of game service resources and server equipment resources.

In actual implementation, the above first prop is configured to perform at least one of the following game behaviors in response to the trigger operation: controlling the controlled virtual object to produce a gain effect in the game scene; and/or controlling the update of the specified scene object in the game scene, so that the controlled virtual object and virtual objects other than the controlled virtual object execute the current game in the specified scene object containing the update.

For example, the first prop (for example, the blood-replenishing prop) can act on the controlled virtual object itself or the teammate object. At this time, the first prop can increase the health points of the controlled virtual object, or increase the health points of the teammate object, which is conducive to increasing the game session performance of the controlled virtual object or the team in the game session. The first prop (for example, the attack prop) can also act on other virtual objects other than the controlled virtual object. At this time, the first prop can increase the experience points, object level, object attack ability, etc. of the controlled virtual object after causing damage to other virtual objects, thereby increasing the probability of the controlled virtual object winning, which is conducive to improving the game session performance of the controlled virtual object in the game session.

The first prop can also update the specified scene object in the game scene. The game scene is a virtual world composed of virtual objects of different forms, functions or meanings that are pre-set, and the game session is a process of the virtual objects controlled by the player in the game scene performing the target task. For example, the game scene is composed of virtual terrain, buildings, weather, and pre-set change rules in the scene. In this embodiment, the specified scene object is the virtual object in the game scene, for example, the scene weather, the scene terrain, the range of the target scene area, etc. After the specified scene object is updated, all or part of the virtual objects in the game scene are affected. For example, after the scene weather is changed, all virtual objects in the game scene are affected by the weather, such as reduced moving speed, continuous reduction in health points, etc. In this embodiment, the first prop usually does not directly produce a gain effect on the controlled virtual object. After the first prop is released, all virtual objects in the game scene will have the same effect, or the first prop will have an effect on some virtual objects according to the position of the virtual object. For example, the first prop can change the local terrain of the scene, and the virtual objects located in the local terrain will be affected by the terrain accordingly. Updating the scene objects in the scene by the first prop can speed up the session progress and reduce server pressure.

When the above-mentioned specified trigger event occurs, the player can be provided with a chance to obtain props for free. That is, obtaining props does not consume the resource amount of the controlled virtual object. Specifically, in response to a specified trigger event, at least some alternative props are determined from a specified prop set, the alternative props are displayed, and the resource amount of the specified resource of the controlled virtual object is maintained unchanged. For example, a prop acquisition control is displayed on the graphical user interface, and the player clicks the prop acquisition control once to extract some of the alternative props from the specified prop set, and the extraction process does not consume the resource amount of the specified resource, thereby maintaining the resource amount of the specified resource of the controlled virtual object unchanged.

Further, if none of the above-mentioned alternative props is the prop the player wants, the game system can further provide an opportunity to re-determine the alternative props. Specifically, in response to the second trigger operation, the resource amount of the specified resource of the controlled virtual object is updated. At least some of the alternative props are re-determined from the specified prop set, and the determined alternative props are updated and displayed.

For example, the above-mentioned second trigger operation can be a re-click operation acting on the prop acquisition control, and the resource amount consumed can be related to the number of operations of the second trigger operation. For example, the more times the second trigger operation is performed, the more resource amount a single second trigger operation consumes. The specified resources of the aforementioned controlled virtual object are the virtual currency owned by the game account corresponding to the controlled virtual object outside the current game session, where the virtual currency is configured to obtain virtual items provided by the game outside the session. In this method, global resources need to be consumed when re-acquiring props, that is, the resources in the game account of the controlled virtual object, such as gold coins, virtual currency, etc. in the game account.

In a specific method, when a player needs to obtain multiple opportunities to determine alternative props, resources need to be consumed, such as gold coins, diamonds, coupons, etc. Each time the alternative props are re-determined, the amount of resources required to be consumed can be the same or different. In an example, five opportunities to re-determine the alternative props can be pre-set, and the resource amount consumed increases successively. For example, when the alternative props are re-determined for the first time, 5 gold coins are consumed, and when the alternative props are re-determined for the second time, 10 gold coins are consumed, etc. When the player has determined the alternative props once, a prompt message can be displayed on the prop acquisition control or around the prop acquisition control to prompt the player the resource amount that needs to be consumed when clicking the prop acquisition control again to determine the alternative props. Each time the alternative props are determined, some alternative props are randomly drawn from the specified prop set and displayed on the interface.

In this way, players can obtain multiple opportunities to draw props by consuming resources, thereby increasing the player's chance of obtaining the desired props, making the player's game session decision more diversified, and increasing the player's game participation and interest, improving the utilization rate of service resources, making full use of game service resources and server equipment resources, and avoiding idling and waste of game service resources and server equipment resources.

In one specific implementation, in response to the current game session reaching a preset game session progress, at least some alternative props are determined from a specified prop set and displayed. This preset session progress can be a session duration, an intermediate result of a session, etc. For example, when the number of surviving virtual objects in the game scene reaches a preset number, it can be understood that the game session reaches a preset session progress. One or more preset session progresses can be set; upon reaching each progress, a prop acquisition control is displayed, giving the player one opportunity to acquire a prop.

Furthermore, the preset session progresses can be one or more session durations. In response to the current game session's duration reaching a preset duration, at least some alternative props are determined from a specified prop set and displayed. For example, when a game session can be preset with a total duration, one or more intermediate durations within that total duration are selected as the preset session progresses. For example, the total duration of the game session is 15 minutes, with five preset durations: 2 minutes, 4 minutes, 6 minutes, 8 minutes, and 10 minutes. That is, every two minutes during the game progress, an alternative prop is retrieved from a specified prop set.

In another method, in response to the object level of the controlled virtual object increasing during the game session, at least some alternative props are determined from the specified prop set and displayed.

When the controlled virtual object first enters the game scene, i.e., at the start of the game session, an initial value of the object level can be preset, such as level zero or level one. Multiple object levels and corresponding experience thresholds can also be preset. As the experience parameter increases and reaches the experience threshold corresponding to the next level, the object level is increased from the current level to the next level.

This embodiment aims to provide diverse game props in the game session to meet players' combat needs and promote the development and growth of game characters. Therefore, when the controlled virtual object increases its object level by one level, a prop acquisition control is displayed in the graphical user interface. The prop acquisition control can be displayed at a specified position in the graphical user interface. It can also display a prompt message to guide the player to acquire the prop by triggering the control.

The experience parameter of the controlled virtual object is increased according to preset rules; in response to the experience parameter reaching a preset experience threshold, the object level of the controlled virtual object in the game session is increased.

The controlled virtual object can perform actions such as moving, attacking, throwing props, shooting, and picking up props in the game scene. The aforementioned preset rules may include: interactive actions that can increase experience parameters, and the corresponding increase in experience parameter for each interactive action; additionally, the increase in the experience parameter can be determined based on the result of the interactive action. For example, in an attack, the increase in the experience parameter is determined based on the decrease amount of health points of the attacked object, or the number of objects defeated by the attack. Based on this, when the controlled virtual object performs interactive actions in the game scene, the experience parameter of the controlled virtual object can be determined based on the interactive action or the result of the interactive action.

In practical implementation, when a controlled virtual object first enters the game scene, i.e., at the start of the game session, an initial value for an experience parameter can be preset. Then, as the game session progresses, the experience parameter is gradually increased based on this initial value.

In response to a specified trigger event, a prop acquisition control is displayed in the graphical user interface. In response to a first trigger operation acting on the prop acquisition control, at least some alternative props are determined from a specified prop set, and these alternative props are displayed. The specified prop set is determined based on the session progress of the current game session.

The prop acquisition control can be displayed at a specified position in the graphical user interface. It can also display prompt information to guide the player to acquire props by triggering the prop acquisition control. After responding to the specified trigger event, the game system can display the aforementioned prop acquisition control on the terminal device corresponding to each surviving virtual object. Then, the player corresponding to each surviving virtual object can determine the alternative props using the prop acquisition control. The alternative props corresponding to different virtual objects can be the same or different. For some special props, only one virtual object can acquire and use them in one game session.

Using prop acquisition control to obtain alternative props ensures uninterrupted game session and improves the smoothness of game actions of the player.

Below is a specific interface interaction method.

In response to a specified trigger event, an interactive prompt control is displayed in the graphical user interface. The interactive prompt control is configured to: prompt the player to perform the interactive operation of acquiring props; and in response to a trigger operation on the interactive prompt control, the prop acquisition control is displayed in the GUI.

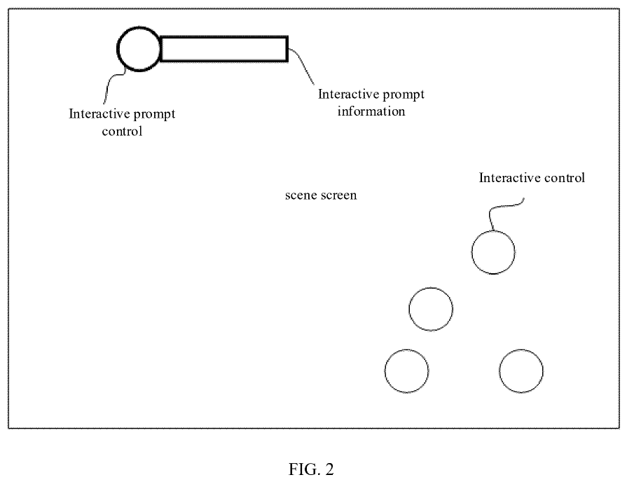

As shown in FIG. 2, during a game session, the scene screen of the game scene is displayed in the graphic user interface (GUI), with various interactive controls displayed above the scene screen. After a specified trigger event occurs, the interactive prompt control is displayed in the GUI. The interactive prompt control can be displayed in a highlighted or flashing format to attract the player's attention. Meanwhile, interactive prompt information can be displayed around the interactive prompt control, indicating that triggering the interactive prompt control will allow the acquisition of props, etc.

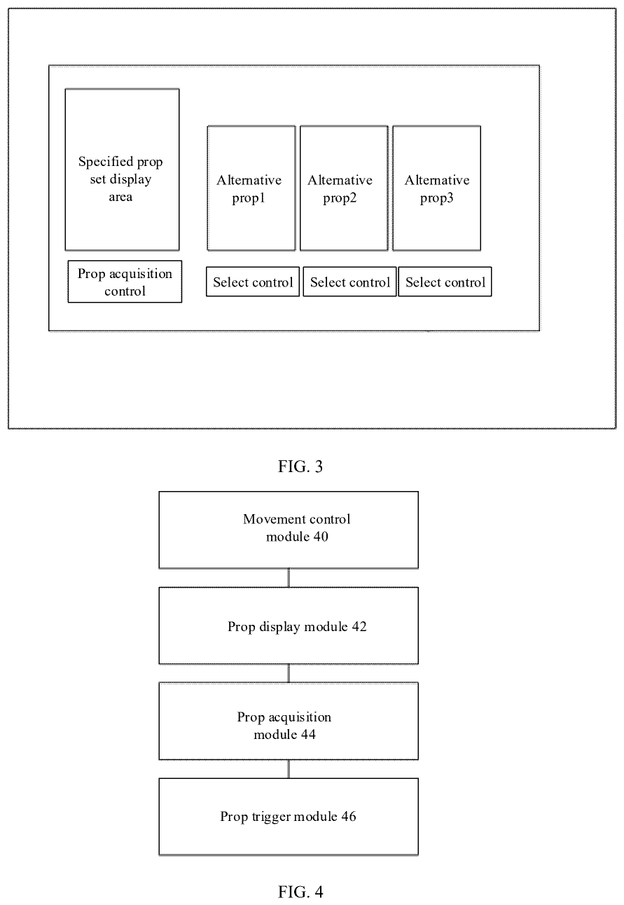

As shown in FIG. 3, when the interactive prompt control in FIG. 2 is triggered, a window is generated in the GUI, and the prop acquisition control is displayed in the window. Before the prop acquisition control is triggered, the window may only display set information about the specified prop set, such as the types and attributes of the props in the set. After the prop acquisition control is triggered, the window can display the alternative props determined from the specified prop set. In the example in FIG. 3, three alternative props are determined, each corresponding to a selection control. The player selects the first prop by triggering the selection control.

The following embodiments describe the method for determining the specified prop set.

Based on the session progress of the current game session or the session level of the controlled virtual object, at least one specified prop set is determined from multiple alternative prop sets; wherein the prop attributes of the props in different alternative prop sets are different. There may be many props in the game system. Props can be classified into multiple alternative prop sets according to their function, triggering method, target, etc.; the props in different prop item sets may be different or partially different; or multiple alternative prop sets can be obtained by classifying props from different dimensions based on different prop attributes.

Next, the session progression corresponding to each alternative prop set is set. After the aforementioned specified trigger event occurs, one or more alternative prop sets are determined as the specified prop set based on the current session progression.

Additionally, the specified prop set can be determined from the alternative prop sets based on the object level of the controlled virtual object. Different object levels may correspond to different or partially different specified prop sets, allowing the controlled virtual object to acquire props of different types or attributes at different object levels.

In one specific implementation, the alternative prop set includes an active prop set, a passive prop set, and a scene prop set. The active prop set includes active props. When an active prop is released, its function is applied to a target object for prop release of the active prop. The passive prop set includes passive props. When a passive prop is acquired by a controlled virtual object, its function is applied to a target object for prop release of the passive prop. The scene prop set includes scene props. When a scene prop is released, its function is applied to the target scene location for prop release of the scene prop. Both the controlled virtual object and other virtual objects are affected; that is, after a scene item is released, all virtual objects in the game scene will be affected by the scene prop.

The active props described above can be understood as props that, when actively released by a controlled virtual object, provide a gain effect to itself. Active props can be used multiple times and have preset cool-down time. When a controlled virtual object is defeated, the active prop will not drop or be picked up by other virtual objects. Active props can include the props shown in Table 1 below, which also shows the corresponding prop effects.

TABLE 1

| Prop name | Prop effect |
|---|---|
| Time-frozen | Upon use, with the controlled virtual object as the center |
| prop | of the circle, change the time flow rate within a radius |
| | of 100 m around it within 10 s, and the behavior of other |
| | objects except itself will become sluggish. |
| Petrification | Upon use, the controlled virtual object will immediately |
| prop | ibecome mmobilized and enter an invulnerable state |
| | for 3 seconds, immune to all damage from enemy objects. |
| | Any active actions such as moving or attacking will |
| | interrupt the petrification state. |
| Burst | Upon use, the controlled virtual object will experience a |
| mobility | burst of high mobility for 5 seconds, significantly |
| prop | increasing both movement speed and jump height. |
| Turrent prop | Upon use, the controlled virtual object will construct a |
| | turret at its current location, which will automatically |
| | attack visible targets within a range of 200 meters. |
| Health points | Upon use, the controlled virtual object will deploy a health |
| field prop | points field at its current location, and friend objects in the |
| | range continuously reply health points. |
| Super jump | Upon use, the controlled virtual object will perform a super |
| prop | jump in the target direction. Upon landing, it will deal |
| | damage to enemies within a 10-meter radius. |

The above passive props can be understood as props that are permanently present after the controlled virtual object obtains them, and can continuously generate a gain effect for the player without being actively triggered by the controlled virtual object. Passive props and active props can jointly build a comprehensive skill framework for the player, and passive props may not fall or be picked up by other virtual objects. Passive props may include the props shown in the following Table 2, which also shows the corresponding prop effects:

TABLE 2

| Prop name | Prop effect |
|---|---|
| Tracking | After hitting an enemy object, it can track the enemy's |
| prop | location. |
| Deception | Upon being hit, the controlled virtual object triggers an |
| prop | illusion effect, creating three illusionary objects that split |
| | off in different directions from the original object. |
| Detection | Centered on the controlled virtual object, it automatically |
| prop | scans a radius of 100 meters every 1 minute, highlighting |
| | any enemy objects detected within that area. |
| Titan prop | When the controlled virtual object is knocked down after |
| | being attacked, it can retaliate using a pistol prop. |
| Stealth | When the controlled virtual object remains stationary, it |
| prop | enters a stealth state, making it difficult for other objects |
| | to detect. |
| Movement | After the controlled virtual object is attacked, its movement |
| speed prop | speed is increased. |
| Turrent prop | After hitting an enemy object, it reduces the enemy's |
| | ability to restore health points. |
| Sniper prop | Allows the user to draw powerful weapons from the |
| | arsenal. |

In addition, except the active props and passive props provided above, scene props are also provided. The scene props can also be called strategic props. After the scene props are used, the global weather, terrain or original state of the target scene area of the game scene is changed, and the initial state of the specified object in the game scene is changed. In a game session, each scene prop can be obtained only once, and the scene prop disappears after use. If the virtual object that obtains the scene prop is defeated, the scene prop can fall into the game scene, and the surviving virtual object can pick it up and use it. In this embodiment, a virtual object can carry at most one scene prop.

For example, a target scene area usually appears in the game scene. In some games, the area range of the target scene area is also called a toxic zone. The above-mentioned scene props may include a toxic zone prop, which is configured to change the changing speed of the toxic zone, the range of the toxic zone, etc. The above-mentioned scene props may also include a weather prop, which is configured to change the weather in the game scene to foggy days, dark nights, snowstorms, sandstorms, thunderstorms, etc. The above-mentioned scene props may also include a terrain prop, which is configured to generate swamp terrain, low gravity terrain, skill failure terrain, etc. in specific scene areas.

Based on the above-mentioned various types of alternative prop sets, when determining the specified prop set, in a specific implementation method, if the session progress of the current game session is an early progress, the specified prop set includes an active prop set. If the session progress of the current game session is the mid-term progress, the specified prop set includes a passive prop set. In the current game session, the mid-term progress is located after the early progress. If the session progress of the current game session is a late progress, the specified prop set includes a scene prop set. In the current game, the late progress is located after the mid-term progress.

In the above method, players can select an active prop at the beginning of the game session. Then, based on the active prop, players can choose to match a passive prop in the middle and late stages of the game session, and then choose a scene prop in the late stage of the game session, so that players can use different props in the progress of participating in the game session. Their competitive performances are improved through the combination of different props.

As an example, the game session progress can be divided into five progresses. The first progress is an early progress, and the specified prop set is the active prop set. The second progress and the third progress are mid-term progresses, and the specified prop set is the passive prop set. The fourth progress and the fifth progress are late stage progresses, and the specified prop set includes the passive prop set and the scene prop set.

In another way, based on the above-mentioned various types of alternative prop sets, when determining the specified prop set, in a specific implementation method, if the object level of the controlled virtual object is the first level, the specified prop set includes an active prop set. If the object level of the controlled virtual object is the second level, the specified prop set includes a passive prop set. In the current game session, the second level is higher than the first level. The object level of the controlled virtual object increases from the first level to the second level. If the object level of the controlled virtual object is the third level, the specified prop set includes an environmental prop set. In the current game session, the third level is higher than the second level. The object level of the controlled virtual object increases from the second level to the third level.

In the above-mentioned way, when the object level is low, such as the first level, the player can select an active prop. Then, based on the active prop, when the object level is a medium level, such as the second level, the player chooses to match a passive prop. Then, at a higher level, such as the third level, the player chooses the environmental prop, so that the player uses different props in the process of participating in the game session, and improves the competitive performance through the combination of different props.

As an example, the object level can be divided into six levels, among which a control for obtaining props is not provided at the zeroth level. At the first level, the specified prop set is an active prop set. At the second and third levels, the specified prop set is a passive prop set. At the fourth level, the specified prop sets are a passive prop set and an environmental prop set. At the fifth level, the specified prop set is an environmental prop set.

After determining the specified prop set, in order to increase the player's interest in obtaining props and make the player's game decision more diversified, the alternative props can be determined in a random manner. Specifically, in response to a specified trigger event, at least some alternative props are randomly determined from the specified prop set, and the alternative props are displayed. As shown in FIG. 3, after the player clicks the prop acquisition control, the game system randomly determines three alternative props from the specified prop set, each of which is displayed in the interface, and the prop usage, prop effect and other information of each alternative prop can also be displayed. The player can select a prop from multiple alternative props, and after obtaining the prop, the player can put it in the backpack to carry it, or use the prop.

Some special props can be set in the game to limit the number of times these props are used in a game session. Based on this, it is necessary to limit the number of times these props are determined as alternative props in the process of determining alternative props. In a specific implementation, if the first prop belongs to a scene prop set, the first prop is deleted from the scene prop set to obtain an updated scene prop set. The updated scene prop set is configured to provide scene props to virtual objects other than the controlled virtual object in the current game session.

In this method, it is preset that each scene prop is only obtained once in a game session. Based on this, if the determined alternative props include a scene prop and the player selects the scene prop, that is, the above-mentioned first prop is a scene prop, then the first prop is deleted from the scene prop set in advance when other players determine the alternative props from the scene prop set, in order to prevent other players from selecting the same scene prop.

In actual implementation, after the specified trigger event occurs, the aforementioned prop acquisition control can be displayed on the terminal device corresponding to each virtual object surviving in the game session, but the time sequence of the players operating the prop acquisition control is sequential, so the player who first operates the prop acquisition control can randomly determine the alternative props from all the scene props in the scene prop set, and the subsequent player who operates the prop acquisition control needs to randomly determine the alternative props from the scene prop set with the acquired prop deleted.

According to the aforementioned embodiment, the scene props can affect the specified scene state of the game scene. The following embodiment describes the specific impact of different prop types of the first prop on the game scene when the first prop acquired by the controlled virtual object is a scene prop.

In actual implementation, the first prop is configured to: update the specified scene state of the game scene; update the specified scene state of the game scene in response to the release operation of the first prop; update the object states of at least part of the virtual objects based on the updated specified scene state. It should be noted that after the first prop is released, the specified scene state of the game scene is updated, and the specified scene state may affect the object states of all or part of the virtual objects in the game scene, such as scene visibility, health points, skill release ability, etc. The specified scene state can continue to affect till the end of the game session, or it can only affect for a certain period of time.

In this way, props can affect the scene state, and affect the object states of virtual objects through the scene state. The richness of props is increased, which can add a variety of game experience for players, promote the session progress, improve the competitiveness of the game, improve the utilization rate of service resources, make full use of game service resources and server equipment resources, and avoid idling and waste of game service resources and server equipment resources.

In an implementation of the scene prop, the scene prop can change the range or changing speed of the target scene area. Specifically, a target scene area is preset in the game scene. The area range of the target scene area changes according to a default area adjustment rule based on the session progress of the current game session. For example, the area range can gradually increase or decrease. The object attributes of the virtual objects in the scene area outside the target scene area change according to the default attribute adjustment rule. For example, the health points gradually decrease or increase, the skill attribute gradually decreases or increases, etc.

In response to the release operation for the first prop, the area range of the target scene area is controlled to be changed, and/or the area range change time of the target scene area is controlled to be changed according to the rule adjustment parameter corresponding to the first prop, where the rule adjustment parameter is different from the default area adjustment rule. The first prop can increase or decrease the area range of the target scene area, or change the position of the target scene area in the game scene. The first prop can also advance or delay the change time of the area range, or pause the change of the area range, etc. After the first prop is released, the aforementioned method of adjusting the target scene area according to the default area adjustment rule is changed, so that the target scene area is adjusted according to the rule adjustment parameter corresponding to the first prop, and the changing rule of the target scene area is changed.

In this method, by changing the area range of the target scene area, the object state of the virtual object in the game session can be affected, thereby changing the game session state of the game session to a certain extent and affecting the final game session result. The prop can increase the uncertainty of the game session and increase the interest and freshness of the player in participating in the game session.

As an example, the area range of the target scene area is gradually reduced based on the game session progress of the current game session. The health points of the virtual object in the scene area outside the target scene area is gradually reduced. In some games, the area range of the target scene area is also called a toxic zone. The health points of the virtual object outside the area range is constantly decreasing until it is defeated, and the health points of the virtual object within the area range is not affected by the environment.

In response to the release operation for the first prop, the area range of the target scene area is updated based on the position of the controlled virtual object in the game scene. For example, the position of the controlled virtual object in the game scene is used as the center position of the target scene area, and the position area of the area range in the game scene is updated, and the center position of the updated scene position is the position of the controlled virtual object. In addition, after the first prop is released, the area range can be updated immediately according to the position of the controlled virtual object, or it can be updated according to the position of the controlled virtual object at the next time the area range is updated. In order to ensure the rationality of the area range update, the first prop can be released only when the controlled virtual object is within the target scene area.

After the area range of the target scene area changes, some virtual objects may be transformed from within the target scene area to outside the target scene area, or some virtual objects may be transformed from outside the target scene area to within the target scene area.

This method changes the environment of the game scene, which is conducive to the controlled virtual object being in the most favorable environment area, and can improve the competitive performance of the controlled virtual object.

In another example, the area range of the target scene area gradually shrinks based on the game session progress of the current game session. The health points of the virtual objects in the scene area outside the target scene area gradually decreases. In response to the release operation for the first prop, if the release time of the first prop belongs to the static stage of the area range of the target scene area, the changing time of the area range of the target scene area is advanced or delayed. If the release time of the first prop belongs to change stage of the area range of the target scene area, the changing speed of the area range of the target scene area is increased or slowed down.

In the game session, in some time stages, the area range of the target scene area remains unchanged, which is called the static stage of the area range. In some time stages, the area range of the target scene area gradually shrinks, which is called the change stage of the area range. When the first prop acts as an acceleration prop, the first prop can be used at any stage of the game session. If the first prop is released in the static stage of the area range of the target scene area, the area range of the target scene area can start to shrink in advance. If the first prop is released in the change stage of the area range of the target scene area, the shrinking of the area range can be accelerated.

When the first prop is used as a stop prop, the first prop can be used at any stage of the game session. If the first prop is released during the static stage of the area range of the target scene area, the area range of the target scene area can be reduced later. If the first prop is released during the change stage of the area range of the target scene area, the reduction process of the area range can be suspended for a preset time period, such as 1 minute.

In the above manner, the scene prop can change the changing pattern of the target scene area in the game scene, have a more obvious impact on the game session state of the game session, make the game session state more favorable to the controlled virtual object, and improve the competitive performance of the controlled virtual object.

In another implementation of the scene prop, the scene prop can change the weather of all or part of areas in the game scene. Specifically, in response to the release operation of the first prop, the scene weather of the game scene is controlled to be converted to the target weather. The target weather is configured to produce an effect corresponding to the target weather on the object state of the virtual object in the game scene. In actual implementation, the first prop can change the entire weather of the game scene, or only change the weather in part of the scene area. The weather can affect the object state of the virtual object located in the weather, such as health points, mobility, skill release ability, etc., thereby indirectly affecting the game session state of the game session.

For example, the target weather includes at least one of foggy weather, night weather, snowstorm weather, sandstorm weather or thunderstorm weather. The foggy weather or the night weather is configured to reduce the visibility of the virtual object, which is not conducive to the player's observation of the surrounding scene environment and other virtual objects. In actual implementation, for the night weather, the scene brightness of the game scene can be reduced, and for the foggy weather, smoke effects can be added to the game scene, thereby reducing the visual clarity of the virtual object in the game scene.

It should be noted that each virtual object in the game scene will be affected by the target weather, including the controlled virtual object.

For the snowstorm weather, the snowstorm weather is configured to reduce the health points of the virtual object, and certain conditions can also be set. For example, when the energy points of the virtual object are low, the snowstorm weather can continuously reduce the health points of the virtual object. Specifically, the snowstorm special effect can be added to the game scene, and at the same time, the health points of the virtual object in the game scene are controlled to continue to decrease. For example, the reduction rule of the health points is preset, and the health points of the virtual object is reduced based on the rule.

For the sandstorm weather, the sandstorm weather is configured to reduce the mobility of the virtual object. After the virtual object enters the sandstorm weather, the movement speed is reduced. Specifically, the sandstorm special effect can be added to the game scene, and at the same time, the movement speed of the virtual object is reduced. For example, when the player issues the same movement control instruction, the default movement speed is multiplied by a parameter less than 1, thereby reducing the movement speed of the virtual object.

For the thunderstorm weather, the thunderstorm weather is configured to reduce the shooting ability of the virtual object. For example, in the thunderstorm weather, the virtual object's aiming accuracy is reduced. After shooting with a gun prop, the recoil is increased, which reduces the shooting stability. The special effects of the thunderstorm weather can also be added to the game scene. When the player controls the gun prop to shoot, a certain recoil parameter value is added on the basis of the default recoil parameter value of the gun prop, thereby reducing the shooting stability of the gun prop.

In actual implementation, after the first prop is released, the target weather can appear within a certain period of time in the future. For example, the target weather appears for one minute and returns to normal weather after one minute. In order to ensure the normal progress of the game session, it can be set that only one target weather can appear in the game scene at the same time. During the time period when the current target weather is effective, other weather cannot take effect.

In another implementation of the scene prop, the scene prop can change the terrain of all or part of areas in the game scene, and affect the object state of the virtual object through the change of terrain. Specifically, in response to a release operation for the first prop, a prop action area is determined based on a prop release position of the first prop. A specified terrain is generated in the prop action area. The specified terrain is configured to generate an effect corresponding to the specified terrain on a virtual object in the specified terrain.

The prop release position may be the same as or different from the position of the controlled virtual object. In one implementation, the prop release position may be selected from a scene map. The prop release range may be pre-set to a fixed size, or the release range may be scaled from the scene map. The prop action area may be determined based on the prop release position and the prop release range, and then the specified terrain is generated in the prop action area.

Different terrains generally have different effects on virtual objects. As an example, the specified terrain includes swamp terrain, low gravity terrain, or skill failure terrain. In a game scene, when the first prop is released, the regional map or regional model structure of the prop action area may be replaced to display the terrain effect. Then, the virtual object located in the specified terrain is detected, and the relevant object parameters of the virtual object are changed according to the terrain characteristics of the specified terrain.

Specifically, the swamp terrain is configured to reduce the mobility of the virtual object in the swamp terrain. Specifically, the movement speed of the virtual object in the swamp terrain can be reduced. For example, when the player issues the same movement control instruction, the default movement speed is multiplied by a parameter less than 1, thereby reducing the movement speed of the virtual object.

The above-mentioned low-gravity terrain is configured to reduce the jumping ability of the virtual object in the low-gravity terrain. For example, after the virtual object jumps, it can jump to a great height, but the falling speed is very slow. After the player issues a jump control instruction, the jumping height is increased based on the default jumping height, and the falling speed is reduced based on the default falling speed. This method may expose the position of the virtual object and increase the probability of being hit by other virtual objects.

The above-mentioned skill failure terrain is configured to reduce the skill release ability of the virtual object in skill failure terrain. For example, in skill failure terrain, the virtual object cannot use all or part of the prop skills. After the player issues a skill release instruction, the skill release instruction is not responded, or the skill release function is reduced, for example, the skill damage ability is reduced, or the skill release range is reduced.

Corresponding to the above method embodiment, referring to the schematic diagram of an interactive control device in a game shown in FIG. 4, a graphical user interface is provided through a terminal device. The graphical user interface includes a current game session interface. The current game session interface includes a game scene and a controlled virtual object located in the game scene. The controlled virtual object is controlled by the terminal device. The device includes:
a movement control module 40, configured to control the controlled virtual object to move in the game scene; where the game scene includes multiple virtual objects, and the controlled virtual object belongs to one of the multiple virtual objects;
a prop display module 42, configured to determine at least some alternative props from a specified prop set in response to a specified trigger event, and display the alternative props;
a prop acquisition module 44, configured to control the controlled virtual object to obtain a first prop in response to a selection operation for the first prop in the alternative props;
a prop trigger module 46, configured to control execution of a game behavior corresponding to the first prop in the game scene in response to a trigger operation for the first prop.

In the above interactive control device in the game, a graphical user interface is provided through a terminal device. The graphical user interface includes a current game session interface. The current game session interface includes a game scene and a controlled virtual object located in the game scene. The controlled virtual object is controlled by the terminal device. The controlled virtual object is controlled to move in the game scene, where the game scene includes multiple virtual objects. The controlled virtual object belongs to one of the multiple virtual objects. In response to a specified trigger event, at least some alternative props are determined from a specified prop set, and the alternative props are displayed. In response to a selection operation on a first prop among the alternative props, the controlled virtual object is controlled to obtain the first prop. In response to a trigger operation on the first prop, the game behavior corresponding to the first prop is controlled to be executed in the game scene. In a game session, alternative props are determined from a prop set, and players can select props from the alternative props. This method enriches the acquisition ways of game props, and different props can be obtained according to the changes in the session progress, making the functions and types of game props richer, improving the competitive experience of players participating in the game session, improving the utilization rate of service resources, making full use of game service resources and server equipment resources, and avoiding idling and waste of game service resources and server equipment resources.

In some examples, the first prop is configured to perform at least one of the following game behaviors in response to the trigger operation: controlling the controlled virtual object to generate a gain effect in the game scene; and/or controlling the update of the specified scene object in the game scene, so that the controlled virtual object and virtual objects other than the controlled virtual object execute the current game session in the specified scene object containing the update.

In some examples, the prop display module is further configured to determine at least some alternative props from the specified prop set in response to a specified trigger event, display the alternative props, and maintain the resource amount of the specified resource of the controlled virtual object unchanged. The above-mentioned device further includes an update display module, configured to update the resource amount of the specified resource of the controlled virtual object in response to the second trigger operation, re-determine at least some alternative props from the specified prop set, and update the display of the determined alternative props.

In some examples, the specified resource of the controlled virtual object is the virtual currency owned by the game account corresponding to the controlled virtual object outside the current game session, where the virtual currency is configured to obtain virtual items provided by the game outside the game session.

In some examples, the prop display module is further configured to determine at least some alternative props from the specified prop set in response to the current game session reaching a preset session progress, and display the alternative props.

In some examples, the prop display module is further configured to determine at least some alternative props from the specified prop set in response to the duration of the current game session reaching a preset duration, and display the alternative props.

In some examples, the prop display module is further configured to determine at least some the alternative props from the specified prop set in response to the increase of the object level of the controlled virtual object in the game session, and display the alternative props.

In some examples, the interactive control device in the game further includes a level increase module, configured to increase the experience parameter of the controlled virtual object according to a preset rule; and increase the object level of the controlled virtual object in the game session in response to the experience parameter reaching a preset experience threshold.

In some examples, the prop display module is further configured to display a prop acquisition control in a graphical user interface in response to a specified trigger event; determine at least some alternative props from the specified prop set in response to a first trigger operation acting on the prop acquisition control, and display the alternative props. The specified prop set is determined based on the session progress of the current game session.

In some examples, the prop display module is further configured to display an interactive prompt control in a graphical user interface in response to a specified trigger event. The interactive prompt control is configured to prompt to perform an interactive operation for acquiring props; and display a prop acquisition control in the graphical user interface in response to a trigger operation on the interactive prompt control.

In some examples, the device further includes a set determination module, configured to determine at least one specified prop set from multiple alternative prop sets based on the session progress of the current game session or the object level of the controlled virtual object. The prop attributes of the props in different alternative prop sets are different.

In some examples, the alternative prop sets include an active prop set, a passive prop set and a scene prop set. The active prop set includes an active prop. After the active prop is released, the prop function is released for the prop release target object of the active prop. The passive prop set includes a passive prop. After the passive prop is acquired by the controlled virtual object, the prop function is released for the prop release target object of the passive prop. The scene prop set includes a scene prop. After the scene prop is released, the prop function is released for the target scene position of the prop release of the scene prop, and both the controlled virtual object and the virtual objects are affected.

In some examples, the set determination module is further configured to: if the session progress of the current game session is an early progress, the specified prop set includes an active prop set; if the session progress of the current game session is a mid-term progress, the specified prop set includes a passive prop set, in the current game session, the mid-term progress is located after the early progress; if the session progress of the current game session is a late progress, the specified prop set includes a scene prop set, in the current game session, the late progress is located after the mid-term progress.

In some examples, the set determination module is further configured to: if the object level of the controlled virtual object is the first level, the specified prop set includes an active prop set; if the object level of the controlled virtual object is the second level, the specified prop set includes a passive prop set, in the current game session, the second level is higher than the first level; the object level of the controlled virtual object increases from the first level to the second level; if the object level of the controlled virtual object is the third level, the specified prop set includes an environment prop set, in the current game session, the third level is higher than the second level; the object level of the controlled virtual object increases from the second level to the third level.

In some examples, the prop display module is further configured to randomly determine at least some the alternative props from the specified prop set in response to a specified trigger event, and display the alternative props.

In some examples, the prop acquisition module is further configured to delete the first prop from the scene prop set if the first prop belongs to the scene prop set, and obtain an updated scene prop set. The updated scene prop set is configured to provide scene props to virtual objects other than the controlled virtual object in the current game session.

In some examples, the first prop is configured to update the specified scene state of the game scene. The above-mentioned prop trigger module is further configured to update the specified scene state of the game scene in response to the release operation for the first prop; and update the object states of at least part of the virtual objects based on the updated specified scene state.

In some examples, a target scene area is preset in the game scene. The area range of the target scene area changes according to a default area adjustment rule based on the session progress of the current game session. The object attributes of the virtual objects in the scene area outside the target scene area change according to the default property adjustment rule. The above-mentioned prop trigger module is further configured to control the change of the area range of the target scene area according to the rule adjustment parameter corresponding to the first prop, and/or change the area range change time of the target scene area in response to the release operation for the first prop, where the rule adjustment parameter is different from the default area adjustment rule.

In some examples, the area range of the target scene area gradually shrinks based on the session progress of the current game session. The health points of the virtual objects in the scene area outside the target scene area gradually decreases. The above-mentioned prop trigger module is further configured to update the area range of the target scene area based on the position of the controlled virtual object in the game scene in response to the release operation of the first prop.

In some examples, the area range of the target scene area gradually shrinks based on the session progress of the current game session. The health points of the virtual objects in the scene area outside the target scene area are gradually reduced. The above-mentioned prop trigger module is further configured to: in response to the release operation for the first prop, if the release time of the first prop belongs to the area range static stage of the target scene area, advance or delay the change time of the area range of the target scene area; if the release time of the first prop belongs to the area range change stage of the target scene area, increase or slow down the change speed of the area range of the target scene area.

In some examples, the prop trigger module is further configured to control the scene weather of the game scene to convert to the target weather in response to the release operation of the first prop. The target weather is configured to produce effect corresponding to the target weather on the object state of the virtual object in the game scene.

In some examples, the target weather includes at least one of: foggy weather, night weather, snowstorm weather, sandstorm weather or thunderstorm weather. The foggy weather or the night weather is configured to reduce the visibility of virtual objects. The snowstorm weather is configured to reduce the health points of virtual objects. The sandstorm weather is configured to reduce the mobility of virtual objects. The thunderstorm weather is configured to reduce the shooting ability of virtual objects.

In some examples, the prop trigger module is further configured to determine the prop action area based on the prop release position of the first prop in response to the release operation for the first prop; generate a specified terrain in the prop action area. The specified terrain is configured to produce an effect corresponding to the specified terrain on the virtual object in the specified terrain.

In some examples, the specified terrain includes at least one of swamp terrain, low gravity terrain, and skill failure terrain. The swamp terrain is configured to reduce the mobility of the virtual object in the swamp terrain. The low gravity terrain is configured to reduce the jumping ability of the virtual object in the low gravity terrain. The skill failure terrain is configured to reduce the skill release ability of the virtual object in the skill failure terrain.

This embodiment also provides an electronic device, including a processor and a memory. The memory stores machine executable instructions that can be executed by the processor, and the processor executes the machine executable instructions to implement the above interactive control method in the game. The electronic device can be a server or a terminal device.

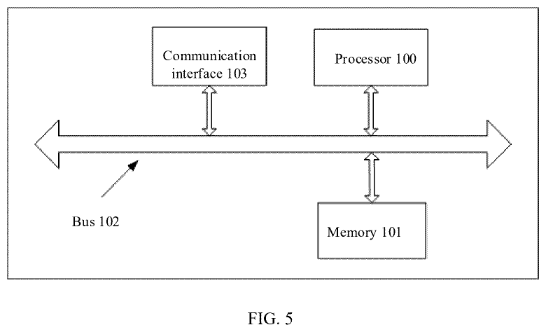

As shown in FIG. 5, the electronic device includes a processor 100 and a memory 101, where the memory 101 stores machine executable instructions that can be executed by the processor 100, and the processor 100 executes the machine executable instructions to implement the above interactive control method in the game.

Further, the electronic device shown in FIG. 5 also includes a bus 102 and a communication interface 103. The processor 100, the communication interface 103 and the memory 101 are connected through the bus 102.

The memory 101 may include a high-speed random access memory (RAM), and may also include a non-volatile memory, such as at least one disk storage. The communication connection between the system network element and at least one other network element is realized through at least one communication interface 103 (which may be wired or wireless), and the Internet, wide area network, local network, metropolitan area network, etc. may be used. The bus 102 may be an ISA bus, a PCI bus or an EISA bus, etc. The bus may be classified into an address bus, a data bus, a control bus, etc. For ease of representation, only one bidirectional arrow is used in FIG. 5, but it does not mean that there is only one bus or one type of bus.

The processor 100 may be an integrated circuit chip with signal processing capabilities. In the implementation process, each step of the above method can be completed by the hardware integrated logic circuit or software instructions in the processor 100. The above processor 100 can be a general-purpose processor, including a central processing unit (CPU), a network processor (NP), etc.; it can also be a digital signal processor (DSP), an application-specific integrated circuit (ASIC), a field-programmable gate array (FPGA) or other programmable logic devices, discrete gates or transistor logic devices, discrete hardware components. The disclosed methods, steps and logic block diagrams in the embodiments of the present disclosure can be implemented or executed. The general-purpose processor can be a microprocessor or the processor can also be any conventional processor, etc. The steps of the method disclosed in conjunction with the embodiments of the present disclosure can be directly embodied as a hardware decoding processor for execution, or a combination of hardware and software modules in the decoding processor for execution. The software module can be located in a mature storage medium in the field such as a random access memory, a flash memory, a read-only memory, a programmable read-only memory or an electrically erasable programmable memory, a register, etc. The storage medium is located in the memory 101, and the processor 100 reads the information in the memory 101, and completes the steps of the method of the above embodiment in combination with its hardware.

The processor in the above electronic device can implement the following operations in the above interactive control method in the game by executing machine executable instructions:

A graphical user interface is provided through a terminal device. The graphical user interface includes a current game session interface. The current game session interface includes a game scene and a controlled virtual object located in the game scene. The controlled virtual object is controlled by the terminal device. The controlled virtual object is controlled to move in the game scene, where the game scene includes multiple virtual objects. The controlled virtual object belongs to one of the multiple virtual objects. In response to a specified trigger event, at least some the alternative props are determined from a specified prop set, and the alternative props are displayed. In response to a selection operation of a first prop among the alternative props, the controlled virtual object is controlled to obtain the first prop. In response to a trigger operation on the first prop, a game behavior corresponding to the first prop is controlled to be executed in the game scene.

In some examples, the first prop is configured to perform at least one of the following game behaviors in response to the trigger operation: controlling the controlled virtual object to generate a gain effect in the game scene; and/or controlling the update of the specified scene object in the game scene, so that the controlled virtual object and virtual objects other than the controlled virtual object execute the current game session in the specified scene object after the update.

In some examples, in response to the specified trigger event, at least some alternative props are determined from the specified prop set, the alternative props are displayed, and the resource amount of the specified resource of the controlled virtual object is maintained unchanged. In response to the second trigger operation, the resource amount of the specified resource of the controlled virtual object is updated. At least some alternative props are re-determined from the specified prop set, and the determined alternative props are updated and displayed.

In some examples, the specified resource of the controlled virtual object is the virtual currency owned by the game account corresponding to the controlled virtual object outside the current game session, where the virtual currency is configured to obtain virtual items provided by the game outside the game session.

In some examples, in response to the current game session reaching a preset session progress, at least some alternative props are determined from the specified prop set, and the alternative props are displayed.

In some examples, in response to the duration of the current game session reaching a preset duration, at least some alternative props are determined from the specified prop set, and the alternative props are displayed.

In some examples, in response to the increase in the object level of the controlled virtual object in the game session, at least some alternative props are determined from the specified prop set, and the alternative props are displayed.

In some examples, the experience parameter of the controlled virtual object is increased according to a preset rule. In response to the experience parameter reaching a preset experience threshold, the object level of the controlled virtual object in the game is increased.

In some examples, in response to a specified trigger event, a prop acquisition control is displayed in a graphical user interface. In response to a first trigger operation acting on the prop acquisition control, at least some alternative props are determined from the specified prop set, and the alternative props are displayed. The specified prop set is determined based on the session progress of the current game session.

In some examples, in response to a specified trigger event, an interactive prompt control is displayed in the graphical user interface. The interactive prompt control is configured to prompt to perform an interactive operation for acquiring props; and display a prop acquisition control in the graphical user interface in response to a trigger operation on the interactive prompt control.

In some examples, at least one specified prop set is determined from multiple alternative prop sets based on the session progress of the current game session or the object level of the controlled virtual object. The props in different alternative prop sets have different prop attributes.

In some examples, the alternative prop sets include an active prop set, a passive prop set and a scene prop set. The active prop set includes an active prop. After the active prop is released, the prop function is released for the prop release target object of the active prop. The passive prop set includes a passive prop. After the passive prop is acquired by the controlled virtual object, the prop function is released for the prop release target object of the passive prop. The scene prop set includes a scene prop. After the scene prop is released, the prop function is released for the target scene position of the prop release of the scene prop, and both the controlled virtual object and the virtual objects are affected.

In some examples, if the session progress of the current game session is an early progress, the specified prop set includes an active prop set. If the session progress of the current game session is a mid-term progress, the specified prop set includes a passive prop set. In the current game session, the mid-term progress is located after the early progress. If the session progress of the current game session is a late progress, the specified prop set includes a scene prop set. In the current game session, the late progress is located after the mid-term progress.

In some examples, if the object level of the controlled virtual object is the first level, the specified prop set includes an active prop set. If the object level of the controlled virtual object is the second level, the specified prop set includes a passive prop set. In the current game session, the second level is higher than the first level. The object level of the controlled virtual object increases from the first level to the second level. If the object level of the controlled virtual object is the third level, the specified prop set includes an environment prop set, In the current game session, the third level is higher than the second level. The object level of the controlled virtual object increases from the second level to the third level.

In some examples, in response to a specified trigger event, at least some alternative props are randomly determined from the specified prop set, and the alternative props are displayed.

In some examples, if the first prop belongs to the scene prop set, the first prop is deleted from the scene prop set to obtain an updated scene prop set. The updated scene prop set is configured to provide scene props to virtual objects other than the controlled virtual object in the current game session.

In some examples, in response to a release operation for the first prop, the specified scene state of the game scene is updated. Based on the updated specified scene state, the object states of at least some virtual objects are updated.

In some examples, a target scene area is preset in the game scene. The area range of the target scene area is changed according to a default area adjustment rule based on the session progress of the current game session. The object attributes of the virtual objects in the scene area other than the target scene area are changed according to the default property adjustment rule. In response to a release operation for the first prop, the area range of the target scene area is changed, and/or the area range change time of the target scene area is changed according to the rule adjustment parameter corresponding to the first prop, where the rule adjustment parameter is different from the default area adjustment rule.

In some examples, the area range of the target scene area is gradually reduced based on the session progress of the current game session. The health points of the virtual object in the scene area outside the target scene area are gradually reduced. In response to the release operation for the first prop, the area range of the target scene area is updated based on the position of the controlled virtual object in the game scene.

In some examples, the area range of the target scene area is gradually reduced based on the session progress of the current game session. The health points of the virtual object in the scene area outside the target scene area are gradually reduced. In response to the release operation for the first prop, if the release time of the first prop belongs to the area range static stage of the target scene area, the change time of the area range of the target scene area is advanced or delayed. If the release time of the first prop belongs to the area range change stage of the target scene area, the change speed of the area range of the target scene area is increased or slowed down.

In some examples, in response to the release operation for the first prop, the scene weather of the game scene is controlled to be converted to the target weather. The target weather is configured to generate an impact corresponding to the target weather on the object state of the virtual object in the game scene.

In some examples, the target weather includes at least one of: foggy weather, night weather, snowstorm weather, sandstorm weather or thunderstorm weather. The foggy weather or the night weather is configured to reduce the visibility of virtual objects. The snowstorm weather is configured to reduce the health points of virtual objects. The sandstorm weather is configured to reduce the mobility of virtual objects. The thunderstorm weather is configured to reduce the shooting ability of virtual objects.

In some examples, the prop action area is determined based on the prop release position of the first prop in response to the release operation for the first prop. A specified terrain is generated in the prop action area. The specified terrain is configured to generate an effect corresponding to the specified terrain on the virtual objects in the specified terrain.

In some examples, the specified terrain includes at least one of: swamp terrain, low gravity terrain, and skill failure terrain. The swamp terrain is configured to reduce the mobility of virtual objects in the swamp terrain. The low gravity terrain is configured to reduce the jumping ability of virtual objects in the low gravity terrain. The skill failure terrain is configured to reduce the skill release ability of virtual objects in the skill failure terrain.

In the above method, in the game session, the alternative props are determined from the prop set, and the player can select the props from the alternative props. This method enriches the acquisition ways of game props, and different props can be obtained according to the changes in the session progress, so that the functions and types of game props are richer, which improves the competitive experience of players participating in the game session, improves the utilization rate of service resources, makes full use of game service resources and server equipment resources, and avoids the idling and waste of game service resources and server equipment resources.

This embodiment also provides a machine-readable storage medium, which stores machine-executable instructions. When the machine-executable instructions are called and executed by the processor, the machine-executable instructions cause the processor to implement the above interactive control method in the game.

The machine executable instructions stored in the machine-readable storage medium can implement the following operations in the interactive control method in the game by executing the machine executable instructions:
providing a graphical user interface through a terminal device; the graphical user interface includes a current game session interface; the current game session interface includes a game scene and a controlled virtual object located in the game scene; the controlled virtual object is controlled by the terminal device; the controlled virtual object is controlled to move in the game scene; where the game scene includes multiple virtual objects; the controlled virtual object belongs to one of the multiple virtual objects; in response to a specified trigger event, at least some alternative props is determined from a specified prop set, and the alternative props are displayed; in response to a selection operation for a first prop in the alternative props, the controlled virtual object is controlled to obtain the first prop; in response to a trigger operation for the first prop, a game behavior corresponding to the first prop is controlled to be executed in the game scene.

In some examples, the first prop is configured to perform at least one of the following game behaviors in response to the trigger operation: controlling the controlled virtual object to generate a gain effect in the game scene; and/or controlling the update of the specified scene object in the game scene, so that the controlled virtual object and virtual objects other than the controlled virtual object execute the current game session in the specified scene object after the update.

In some examples, in response to the specified trigger event, at least some alternative props are determined from the specified prop set, the alternative props are displayed, and the resource amount of the specified resource of the controlled virtual object is maintained unchanged; in response to the second trigger operation, the resource amount of the specified resource of the controlled virtual object is updated; at least some alternative props are re-determined from the specified prop set, and the determined alternative props are updated and displayed.

In some examples, the specified resource of the controlled virtual object is the virtual currency owned by the game account corresponding to the controlled virtual object outside the current game session, where the virtual currency is configured to obtain virtual items provided by the game outside the game session.

In some examples, in response to the current game session reaching a preset session progress, at least some alternative props are determined from the specified prop set, and the alternative props are displayed.

In some examples, in response to the duration of the current game session reaching a preset duration, at least some alternative props are determined from the specified prop set, and the alternative props are displayed.

In some examples, in response to the increase in the object level of the controlled virtual object in the game session, at least some alternative props are determined from the specified prop set, and the alternative props are displayed.

In some examples, the experience parameter of the controlled virtual object is increased according to a preset rule. In response to the experience parameter reaching a preset experience threshold, the object level of the controlled virtual object in the game session is increased.

In some examples, in response to a specified trigger event, a prop acquisition control is displayed in a graphical user interface. In response to a first trigger operation acting on the prop acquisition control, at least some alternative props are determined from the specified prop set, and the alternative props are displayed. The specified prop set is determined based on the session progress of the current game session.

In some examples, in response to a specified trigger event, an interactive prompt control is displayed in a graphical user interface. The interactive prompt control is configured to prompt to perform an interactive operation for acquiring props. In response to a trigger operation for the interactive prompt control, a prop acquisition control is displayed in a graphical user interface.

In some examples, based on the session progress of the current game session or the object level of the controlled virtual object, at least one specified prop set is determined from multiple candidate prop sets. The prop attributes of props in different alternative prop sets are different.

In some examples, the alternative prop sets include an active props set, a passive props set and a scene props set. The active props set includes an active prop. After the active prop is released, the prop function is released for the prop release target object of the active prop. The passive prop sets include a passive prop. After the passive prop is acquired by the controlled virtual object, the prop function is released for the prop release target object of the passive prop. The scene prop sets include a scene prop. After the scene prop is released, the prop function is released for the prop release target scene position of the scene prop, and both the controlled virtual object and the virtual objects are affected.

In some examples, if the session progress of the current game session is an early progress, the specified prop set includes an active prop set. If the session progress of the current game session is a mid-term process, the specified prop set includes a passive prop set. In the current game session, the mid-term progress is located after the early progress. If the session progress of the current game session is a late progress, the specified prop set includes a scene prop set. In the current game session, the late progress is located after the mid-term progress.

In some examples, if the object level of the controlled virtual object is the first level, the specified prop set includes an active prop set. If the object level of the controlled virtual object is the second level, the specified prop set includes a passive prop set. In the current game session, the second level is higher than the first level. The object level of the controlled virtual object increases from the first level to the second level. If the object level of the controlled virtual object is the third level, the specified prop set includes an environment prop set. In the current game session, the third level is higher than the second level. The object level of the controlled virtual object increases from the second level to the third level.

In some examples, in response to a specified trigger event, at least some alternative props are randomly determined from the specified prop set, and the alternative props are displayed.

In some examples, if the first prop belongs to the scene prop set, the first prop is deleted from the scene prop set to obtain an updated scene prop set. The updated scene prop set is configured to provide scene props to virtual objects other than the controlled virtual object in the current game session.

In some examples, in response to the release operation for the first prop, the specified scene state of the game scene is updated. Based on the updated specified scene state, the object states of at least part of the virtual objects are updated.

In some examples, a target scene area is preset in the game scene. The area range of the target scene area is changed according to the default area adjustment rule based on the session progress of the current game session. The object attributes of the virtual objects in the scene area outside the target scene area are changed according to the default attribute adjustment rule. In response to the release operation for the first prop, the area range of the target scene area is changed, and/or the area range change time of the target scene area is changed according to the rule adjustment parameter corresponding to the first prop, where the rule adjustment parameter is different from the default area adjustment rule.

In some examples, the area range of the target scene area is gradually reduced based on the session progress of the current game session. The health points of the virtual objects in the scene area outside the target scene area are gradually reduced. In response to the release operation for the first prop, the area range of the target scene area is updated based on the position of the controlled virtual object in the game scene.

In some examples, the area range of the target scene area is gradually reduced based on the session progress of the current game. The health points of the virtual object in the scene area outside the target scene area are gradually reduced. In response to the release operation for the first prop, if the release time of the first prop belongs to the area range static stage of the target scene area, the change time of the area range of the target scene area is advanced or delayed. If the release time of the first prop belongs to the area range change stage of the target scene area, the change speed of the area range of the target scene area is increased or slowed down.

In some examples, in response to the release operation for the first prop, the scene weather of the game scene is controlled to be converted to the target weather. The target weather is configured to generate an effect corresponding to the target weather on the object state of the virtual object in the game scene.

In some examples, the target weather includes at least one of: foggy weather, night weather, snowstorm weather, sandstorm weather or thunderstorm weather. The foggy weather or the night weather is configured to reduce the visibility of virtual objects. The snowstorm weather is configured to reduce the health points of virtual objects. The sandstorm weather is configured to reduce the mobility of virtual objects. The thunderstorm weather is configured to reduce the shooting ability of virtual objects.

In some examples, in response to the release operation for the first prop, the prop action area is determined based on the prop release position of the first prop. A specified terrain is generated in the prop action area. The specified terrain is configured to generate an effect corresponding to the specified terrain on the virtual object in the specified terrain.

In some examples, the specified terrain includes at least one of: swamp terrain, low gravity terrain, and skill failure terrain. The swamp terrain is configured to reduce the mobility of the virtual object in the swamp terrain. The low gravity terrain is configured to reduce the jumping ability of the virtual object in the low gravity terrain. The skill failure terrain is configured to reduce the skill release ability of the virtual object in the skill failure terrain.

In the above method, in the game session, the alternative props are determined from the prop set, and the player can select the props from the alternative props. This method enriches the acquisition ways of game props, and different props can be obtained according to the changes in the session progress, so that the functions and types of game props are richer, the competitive experience of players participating in the game session is improved, the utilization rate of service resources is improved, and the game service resources and server equipment resources are fully utilized, and the idling and waste of game service resources and server equipment resources are avoided.

The interactive control method and device in the game, the computer program product and the electronic device provided by the embodiment of the present disclosure include a computer-readable storage medium storing program code, and the instructions included in the program code can be configured to execute the method described in the previous method embodiment. The specific implementation can refer to the method embodiment, which will not be repeated here.

Those skilled in the art can clearly understand that for the convenience and simplicity of description, the specific working process of the system and device described above can refer to the corresponding process in the above method embodiment, which will not be repeated here.

In addition, in the description of the embodiment of the present disclosure, unless otherwise clearly specified and limited, the terms “installation”, “connection” and “link” should be understood in a broad sense, for example, it can be a fixed connection, a detachable connection, or an integral connection; it can be a mechanical connection or an electrical connection; it can be directly connected, or indirectly connected through an intermediate medium, or it can be the internal connection of two components. For those skilled in the art, the specific meanings of the above terms in the present disclosure can be understood according to the specific situation.

If the function is implemented in the form of a software functional unit and sold or used as an independent product, it can be stored in a computer-readable storage medium. Based on such understanding, the technical solution of the present disclosure, or the part that contributes to the prior art, or the part of the technical solution, can be embodied in the form of a software product, which is stored in a storage medium and includes several instructions for a computer device (which can be a personal computer, a server, or a network device, etc.) to perform all or part of the steps of the method described in each embodiment of the present disclosure. The aforementioned storage medium includes various media such as U disk, mobile hard disk, read-only memory (ROM, Read-Only Memory), random access memory (RAM, Random Access Memory), disk or optical disk, etc. that can store program codes.

In the description of the present disclosure, it should be noted that the terms “center”, “up”, “down”, “left”, “right”, “vertical”, “horizontal”, “inside”, “outside” and the like indicate the orientation or position relationship based on the orientation or position relationship shown in the accompanying drawings, which is only for the convenience of describing the present disclosure and simplifying the description, and does not indicate or imply that the device or element referred to must have a specific orientation, be constructed and operated in a specific orientation, and therefore cannot be understood as a limitation on the present disclosure. In addition, the terms “first”, “second” and “third” are only used for descriptive purposes and cannot be understood as indicating or implying relative importance.

Finally, it should be noted that the above embodiments are only specific implementation methods of the present disclosure, which are used to illustrate the technical solutions of the present disclosure, rather than to limit them. The protection scope of the present disclosure is not limited thereto. Although the present disclosure is described in detail with reference to the above embodiments, those skilled in the art should understand that any person skilled in the art who is familiar with the technical field can still modify the technical solutions recorded in the above embodiments within the technical scope disclosed in the present disclosure, or can easily think of changes, or make equivalent replacements for some of the technical features therein; and these modifications, changes or replacements do not make the essence of the corresponding technical solutions deviate from the spirit and scope of the technical solutions of the embodiments of the present disclosure, and should be covered within the protection scope of the present disclosure. Therefore, the protection scope of the present disclosure shall be subject to the protection scope of the claims.

1. An interactive control method in a game comprising:
providing a graphical user interface through a terminal device, wherein the graphical user interface comprises an interface of a current game session; the interface of the current game session comprises a game scene and a controlled virtual object located in the game scene; the controlled virtual object is controlled by the terminal device;
controlling the controlled virtual object to move in the game scene, wherein the game scene comprises multiple virtual objects, and the controlled virtual object belongs to one of the multiple virtual objects;
in response to a specified trigger event, determining at least some alternative props from a specified prop set, and displaying the alternative props;
in response to a selection operation for the first prop in the alternative props, controlling the controlled virtual object to acquire a first prop; and
in response to a trigger operation for the first prop, controlling to perform a game behavior corresponding to the first prop in the game scene.

2. The method according to claim 1, wherein the first prop is configured to, in response to the trigger operation, perform at least one of:
controlling the controlled virtual object to generate a gain effect in the game scene; or,
controlling to update a specified scene object in the game scene, wherein the controlled virtual object and virtual objects other than the controlled virtual object execute the current game session in an updated specified scene object.

3. The method according to claim 1, wherein in response to the specified trigger event, determining at least some alternative props from the specified prop set and displaying the alternative props comprises: in response to the specified trigger event, determining at least some alternative props from the specified prop set, displaying the alternative props, and maintaining a resource amount of a specified resource of the controlled virtual object unchanged; and
the method further comprises:
in response to a second trigger operation, updating the resource amount of the specified resource of the controlled virtual object; and
re-determining at least some alternative props from the specified prop set, and updating and displaying the determined alternative props.

4. The method according to claim 1, wherein the specified resource of the controlled virtual object is virtual currency owned by a game account corresponding to the controlled virtual object outside a current game session, wherein the virtual currency is configured to obtain virtual items provided by the game outside the session.

5. The method according to claim 1, wherein in response to the specified trigger event, determining at least some alternative props from the specified prop set and displaying the alternative props comprises:
in response to the current game session reaching a preset session progress, determining at least some alternative props from the specified prop set, and displaying the alternative props,
wherein in response to the current game session reaching the preset session progress, determining at least some alternative props from the specified prop set and displaying the alternative props comprises:
in response to a duration of the current game session reaching a preset duration, determining at least some alternative props from the specified prop set, and displaying the alternative props.

6. (canceled)

7. The method according to claim 1, wherein in response to the specified trigger event, determining at least some alternative props from the specified prop set and displaying the alternative props comprises:
in response to an object level of the controlled virtual object in the game session increasing, determining at least some alternative props from the specified prop set, and displaying the alternative props, and
wherein the method further comprises:
increasing an experience parameter of the controlled virtual object according to a preset rule; and
increasing the object level of the controlled virtual object in the game session in response to the experience parameter reaching a preset experience threshold.

8. (canceled)

9. The method according to claim 1, wherein in response to the specified trigger event, determining at least some alternative props from the specified prop set and displaying the alternative props comprises:
in response to the specified trigger event, displaying a prop acquisition control in the graphical user interface; and
in response to a first trigger operation acting on the prop acquisition control, determining at least some alternative props from the specified prop set and displaying the alternative props, wherein the specified prop set is determined based on a session progress of the current game session, and
wherein in response to the specified trigger event, displaying the prop acquisition control in the graphical user interface comprises:
in response to the specified trigger event, displaying an interactive prompt control in the graphical user interface, wherein the interactive prompt control is configured to prompt to perform an interactive operation for prop acquisition; and
in response to a trigger operation on the interactive prompt control, displaying the prop acquisition control in the graphical user interface.

10. (canceled)

11. The method according to claim 1, further comprising:
determining at least one specified prop set from a plurality of alternative prop sets based on a session progress of the current game session or an object level of the controlled virtual object, wherein prop attributes of props in different alternative prop sets are different.

12. The method according to claim 11, wherein the alternative prop sets comprise an active prop set, a passive prop set and a scene prop set;
wherein the active prop set comprises an active prop, and after the active prop is released, a prop function is released for a prop release target object of the active prop;
the passive prop set comprises a passive prop, and after the passive prop is acquired by the controlled virtual object, a prop function is released for a prop release target object of the passive prop; and
the scene prop set comprises a scene prop, and after the scene prop is released, a prop function is released for a target scene position of prop release of the scene prop, and both the controlled virtual object and the virtual objects are affected.

13. The method according to claim 11, wherein determining at least one specified prop set from the plurality of alternative prop sets based on the session progress of the current game session comprises at least one of:
in response to determining that the session progress of the current game session is an early progress, the specified prop set comprises an active prop set;
in response to determining that the session progress of the current game session is a mid-term process, the specified prop set comprises a passive prop set; wherein, in the current game session, the mid-term progress is located after the early progress; and
in response to determining that the session progress of the current game session is a late progress, the specified prop set comprises a scene prop set; wherein, in the current game session, the late progress is located after the mid-term progress.

14. The method according to claim 11, wherein determining at least one specified prop set from the plurality of alternative prop sets based on the object level of the controlled virtual object comprises at least one of:
in response to determining that the object level of the controlled virtual object is a first level, the specified prop set comprises an active prop set;
in response to determining that the object level of the controlled virtual object is a second level, the specified prop set comprises a passive prop set; wherein, in the current game session, the second level is higher than the first level, and the object level of the controlled virtual object increases from the first level to the second level; and
in response to determining that the object level of the controlled virtual object is a third level, the specified prop set comprises an environmental prop set; wherein, in the current game session, the third level is higher than the second level, and the object level of the controlled virtual object increases from the second level to the third level.

15. The method according to claim 1, wherein in response to the specified trigger event, determining at least some alternative props from the specified prop set and displaying the alternative props comprises:
in response to the specified trigger event, randomly determining at least some alternative props from the specified prop set and displaying the alternative props.

16. The method according to claim 1, wherein in response to the selection operation for the first prop in the alternative props, controlling the controlled virtual object to obtain the first prop comprises:
in response to determining that the first prop belongs to a scene prop set, obtaining an updated scene prop set by deleting the first prop from the scene prop set; wherein the updated scene prop set is configured to provide scene props to virtual objects other than the controlled virtual object in the current game session.

17. The method according to claim 1, wherein the first prop is configured to update a specified scene state of the game scene; in response to the trigger operation for the first prop, controlling to perform the game behavior corresponding to the first prop in the game scene comprises:
in response to a release operation for the first prop, updating the specified scene state of the game scene; and
updating object states of at least part of the virtual objects based on the updated specified scene state.

18. The method according to claim 17, wherein a target scene area is preset in the game scene; an area range of the target scene area changes according to a default area adjustment rule based on a session progress of the current game session; an object attribute of a virtual object in a scene area outside the target scene area changes according to a default attribute adjustment rule;
in response to the release operation for the first prop, updating the specified scene state of the game scene comprises: controlling to change the area range of the target scene area, and/or change area range change time of the target scene area according to a rule adjustment parameter corresponding to the first prop in response to the release operation for the first prop, wherein the rule adjustment parameter is different from the default area adjustment rule.

19. The method according to claim 18, wherein the area range of the target scene area is gradually reduced based on the session progress of the current game session; health points of the virtual object in the scene area outside the target scene area are gradually reduced;
controlling to change the area range of the target scene area according to the rule adjustment parameter corresponding to the first prop in response to the release operation for the first prop comprises: updating the area range of the target scene area based on a position of the controlled virtual object in the game scene in response to the release operation for the first prop.

20. The method according to claim 18, wherein the area range of the target scene area is gradually reduced based on the session progress of the current game session; health points of the virtual object in the scene area outside the target scene area are gradually reduced;
controlling to change the area range change time of the target scene area according to the rule adjustment parameter corresponding to the first prop in response to the release operation for the first prop comprises:
in response to the release operation of the first prop, and in response to determining that release time of the first prop belongs to an area range static stage of the target scene area, advancing or delaying the area range change time of the target scene area; and
in response to determining that the release time of the first prop belongs to an area range change stage of the target scene area, increasing or slowing down a change speed of the area range of the target scene area.

21. The method according to claim 17, wherein in response to the release operation for the first prop, updating the specified scene state of the game scene comprises:
controlling a scene weather of the game scene to be converted to a target weather in response to the release operation of the first prop; wherein the target weather is configured to generate an effect corresponding to the target weather on the object states of the virtual objects in the game scene, and
wherein the target weather comprises at least one of: a foggy weather, a night weather, a snowstorm weather, a sandstorm weather or a thunderstorm weather;
wherein the foggy weather or the night weather is configured to reduce visibility of the virtual object;
the snowstorm weather is configured to reduce health points of the virtual object;
the sandstorm weather is configured to reduce mobility of the virtual object; and
the thunderstorm weather is configured to reduce shooting ability of the virtual object.

22. (canceled)

23. The method according to claim 17, wherein in response to the release operation for the first prop, updating the specified scene state of the game scene comprises:
determining a prop action area based on a prop release position of the first prop in response to the release operation for the first prop; and
generating a specified terrain in the prop action area; wherein the specified terrain is configured to generate an effect corresponding to the specified terrain on the virtual object in the specified terrain,
wherein the specified terrain comprises at least one of: a swamp terrain, a low gravity terrain, and a skill failure terrain;
wherein the swamp terrain is configured to reduce mobility of the virtual object in the swamp terrain;
the low gravity terrain is configured to reduce jumping ability of the virtual object in the low gravity terrain; and
the skill failure terrain is configured to reduce skill release ability of the virtual object in the skill failure terrain.

24. (canceled)

25. (canceled)

26. An electronic device, comprising a processor and a memory, wherein the memory stores machine executable instructions that can be executed by the processor, and the processor executes the machine executable instructions to;
providing a graphical user interface through the electronic device, wherein the graphical user interface comprises an interface of a current game session; the interface of the current game session comprises a game scene and a controlled virtual object located in the game scene; the controlled virtual object is controlled by the electronic device;
controlling the controlled virtual object to move in the game scene, wherein the game scene comprises multiple virtual objects, and the controlled virtual object belongs to one of the multiple virtual objects;
in response to a specified trigger event, determining at least some alternative props from a specified prop set, and displaying the alternative props;
in response to a selection operation for the first prop in the alternative props, controlling the controlled virtual object to acquire a first prop; and
in response to a trigger operation for the first prop, controlling to perform a game behavior corresponding to the first prop in the game scene.

27. (canceled)
